(19) United States
(12) Patent Application Publication
(10) Pub. No.: US 2025/0242325 A1
(43) Pub. Date: Jul. 31, 2025

(54) POLYMERIZATION REACTOR AND METHOD FOR PRODUCING PROPYLENE-BASED POLYMER

(71) Applicants: JAPAN POLYPROPYLENE CORPORATION, Tokyo (JP); JNC CORPORATION, Tokyo (JP)

(72) Inventor: Hiroshi MINO, Tokyo (JP)

(73) Assignees: JAPAN POLYPROPYLENE CORPORATION, Tokyo (JP); JNC CORPORATION, Tokyo (JP)

(21) Appl. No.: 18/697,128

(22) PCT Filed: Oct. 20, 2022
(86) PCT No.: PCT/JP2022/039078

§ 371 Date: Nov. 6, 2024

(51) Int. Cl. B01J 19/18; B01J 19/00; C08F 2/01; C08F 110/06

(52) U.S. Cl. CPC B01J 19/18; B01J 19/0066; C08F 2/01; C08F 110/06; B01J 2219/182

(57) ABSTRACT

Provided is a polymerization reactor configured to keep the lubrication condition between the stirrer shaft of the stirrer disposed inside the reaction tank of the polymerization reactor and bearing in good condition, and configured to possess smooth and stable stirring performance and high durability that provides long-term resistance to damage. Also provided is a method for producing a propylene-based polymer. A polymerization reactor comprising: a reaction tank, a stirrer which is disposed inside the reaction tank and which has a stirrer shaft and stirring blades fixed on the stirrer shaft, and a bearing which bears an end portion of the stirrer shaft, wherein, as a lubricant, a fluorine-based oil is used in a gap between the stirrer shaft and the bearing. A method for producing a propylene-based polymer, wherein the polymerization reactor is used.

### TECHNICAL FIELD

The disclosure relates to a polymerization reactor used to synthesize a polymer from a monomer, and a method for producing a propylene-based polymer, in which the polymerization reactor is used.

### BACKGROUND ART

A polymerization reactor provided with a reaction tank and a stirrer is known, in which the reaction tank serves as a polymerization reaction field, and the stirrer has a stirrer shaft and stirring blades fixed on the stirrer shaft and is disposed inside the reaction tank as a device for homogenizing a reaction system that contains a raw material monomer and a catalyst.

Patent Document 1 discloses a stirred-tank reactor comprising a reaction space, a reactor jacket enclosing the reaction space, a stirrer shaft, stirring and/or shearing elements which are non-rotatably connected to the stirrer shaft, a starting material feed port which is at the top in the position of use, and a product discharge port which is at the bottom in the position of use, wherein the product discharge port is in the form of a central bottom outflow port through which the stirrer shaft at least partly passes. The stirred-tank reactor of Patent Document 1 is a so-called vertical reactor.

Patent Document 2 discloses a horizontal reactor comprising the following: a cylindrical tank having a horizontal central axis, a stirrer having a rotating shaft arranged to coincide with the horizontal central axis, a feed port for feeding stirring objects, which is disposed at one end of the cylindrical tank, an outlet port for drawing a product, which is disposed at the other end of the cylindrical tank, and two or more weirs each of which is arranged perpendicular to the rotating shaft and provided with an opening at the bottom to divide the inside of the cylindrical tank into three or more zones, wherein the three or more zones are connected to two or more independent gas-circulation systems for supplying and circulating gas, and a vapor phase-solid phase reaction is carried out in a state that the openings of the weirs are buried by a layer of particles present in the cylindrical tank. The horizontal reactor is characterized in that the stirrer comprises plural paddle-sets each of which is composed of one or more plate paddles fixed at predetermined positions on the rotating shaft along an axial direction, and especially specific restrictions are imposed on the size and positional relationship between the two of the paddle-sets which make a pair and oppose to each other across the weir, and also imposed on the size and positional relationship between the paddle-sets of the respective divided zones. The horizontal reactor of Patent Document 2 is one kind of horizontal reactor.

In general, to dispose the stirrer having the stirrer shaft and the stirring blades fixed on the stirrer shaft at a predetermined position in the reaction tank of the polymerization reactor, a bearing is disposed outside the reaction tank or inside the outer wall of the reaction tank, and at least one end of the stirrer shaft is axis-rotatably born by the bearing.

### CITATION LIST

### Patent Documents

Patent Document 1: Japanese Patent Application Laid-Open (JP-A) No. 2011-514837
Patent Document 2: Japanese Patent Application Laid-Open (JP-A) No. 563-223001

### SUMMARY OF INVENTION

### Technical Problem

Large frictional load is generated at a sliding interface between the stirrer shaft of the stirrer and the inner surface of the bearing of the stirrer. This phenomenon causes a deterioration in stirring performance, such as a reduction in stirring smoothness and stability, and damage to the stirrer shaft or the bearing, and it may finally result in a problem such that the stability of polymerization reaction in the polymerization reactor, the ease of reactor maintenance, and the durability of the whole reactor are deteriorated.

To solve this problem, it is known to use a lubricant in a gap between the stirrer shaft and the bearing for reducing the friction. However, as in the case of a propylene polymerization condition, when olefin monomers are present, the following problem is observed: a decrease in lubrication performance is caused by the dissolution of the monomer into the lubricant, thereby reducing the effects of the lubricant and failing to exhibit desired performance. To achieve smooth and stable stirring performance and high stirrer durability in such a condition, it is required to keep the lubrication condition of the sliding interface between the stirrer shaft of the stirrer and the inner surface of the bearing of the stirrer, in good condition.

In light of the prior art mentioned above, an object of the present invention is to provide a polymerization reactor configured to keep the lubrication condition of the sliding interface between the stirrer shaft of the stirrer disposed inside the reaction tank of the polymerization reactor and the bearing for bearing the stirrer shaft in good condition, and configured to possess smooth and stable stirring performance and high durability that provides long-term resistance to damage.

Another object of the present invention is to provide a method for producing a propylene-based polymer by use of the polymerization reactor having high durability.

### Solution to Problem

To achieve the above objects, the inventor of the present invention conducted investigation and found the following: by using a fluorine-based oil as a lubricant between the stirrer shaft of the stirrer disposed in the reaction tank of the polymerization reactor and the bearing for bearing the stirrer shaft, the lubrication condition can be kept in good condition, and smooth and stable stirring performance and high stirrer durability can be achieved.

The first invention of the present invention is a polymerization reactor comprising:
a reaction tank,
a stirrer which is disposed inside the reaction tank and which has a stirrer shaft and stirring blades fixed on the stirrer shaft, and
a bearing which is at least disposed at a side where one end of the stirrer shaft is present and which bears an end portion of the stirrer shaft,
wherein, as a lubricant, a fluorine-based oil is used in a gap between the stirrer shaft and the bearing.

According to the second invention of the present invention, in the first invention, the fluorine-based oil is perfluoropolyether.

According to the third invention of the present invention, in the first or second invention, the reactor is a horizontally arranged reactor in which the stirrer shaft of the stirrer disposed inside the reaction tank is arranged in an approximately horizontal direction.

According to the fourth invention of the present invention, in any one of the first to third inventions, the reactor is used for olefin polymerization.

According to the fifth invention of the present invention, in the fourth invention, the olefin polymerization is propylene polymerization.

The sixth invention of the present invention is a method for producing a propylene-based polymer, wherein the polymerization reactor of any one of the first to fifth inventions is used.

### Advantageous Effects of Invention

According to the present invention, the polymerization reactor in which the lubrication condition of the sliding interface between the stirrer shaft of the stirrer disposed inside the polymerization reactor and the bearing for bearing the stirrer shaft, is kept in good condition, and which has smooth and stable stirring performance and high durability that provides long-term resistance to damage, is provided.

In addition, according to the present invention, by using the above-mentioned polymerization reactor with high durability, the method which enables easy maintenance of the reactor and long-term stable production of a propylene-based polymer is provided.

### BRIEF DESCRIPTION OF DRAWINGS

FIG. 1 is a schematic diagram showing an exemplary polymerization reaction system (polymerization system 101) for a vapor phase polymerization method, which includes a horizontal reactor 100 according to the present invention.

FIG. 2 is a schematic enlarged diagram showing a part of one end of a stirrer shaft in the reactor 100 shown in FIG. 1, the end being born by a bearing.

### DESCRIPTION OF EMBODIMENTS

Hereinafter, the features of the polymerization reactor of the present invention will be described in detail. The descriptions of the components described below are examples of the embodiments of the present invention, and the present invention is not limited to the following descriptions, unless it is beyond the gist thereof.

In the present invention, “to” which shows a numerical range is used to describe a range in which the numerical values described before and after “to” indicate the lower limit value and the upper limit value.

The polymerization reactor of the present invention is a polymerization reactor comprising: a reaction tank, a stirrer which is disposed inside the reaction tank and which has a stirrer shaft and stirring blades fixed on the stirrer shaft, and a bearing which is at least disposed at one end side of the stirrer shaft and which bears an end portion of the stirrer shaft, wherein, as a lubricant, a fluorine-based oil is used in a gap between the stirrer shaft and the bearing.

The polymerization reactor of the present invention can be used for polymerization (homopolymerization or copolymerization) of various kinds of monomer species. There is no limitation on applicable polymerization modes, and the polymerization reactor is applicable to any of the reaction modes of radical polymerization, cationic polymerization, anionic polymerization and coordination polymerization. Also, there is no limitation on applicable polymerization processes. For example, the polymerization reactor is applicable to any of the polymerization processes of the slurry polymerization method in which polymerization is carried out in an inert hydrocarbon solvent, the bulk polymerization method in which polymerization is carried out in a liquefied monomer, and the vapor phase polymerization method in which polymerization is carried out in a gas phase in the substantial absence of a liquid phase.

The polymerization reactor of the present invention may be applied to batch polymerization or continuous polymerization in which a raw material monomer is continuously supplied to the reaction tank and, while developing a polymerization reaction, a polymer thus produced is drawn. In the case of carrying out multistep polymerization with the polymerization reactor of the present invention, two or more polymerization reactors of the present invention may be connected to carry out multistep polymerization, or the polymerization reactor of the present invention may be connected to a polymerization reactor different from the polymerization reactor of the present invention.

In the polymerization reactor of the present invention, the stirrer having the stirrer shaft and the stirring blades fixed on the stirrer shaft, is placed in the internal space of the reaction tank, and the reaction tank is a container that forms a space serving as a reaction field. For example, the stirrer can be placed in the internal space of a cylindrical reaction tank, and the stirrer shaft of the stirrer may be arranged to coincide with the central axis of the cylindrical internal space of the reaction tank. Two or more stirrers may be disposed inside one reaction tank. In this case, the stirrers may be disposed so that their rotating shafts are in parallel with each other.

The reaction tank is provided with a feed port for feeding starting materials such as catalysts, raw material monomers, comonomers, inert solvents and molecular weight regulators to the inside of the reactor. In addition, the reaction tank is provided with a draw port for drawing a reaction product.

As needed, the reaction tank is also provided with the following: inlet and outlet ports such as a recovery port for recovering unreacted monomers or unreacted gas, a sensor for monitoring the state of the reactor, such as thermometers and pressure meters, and other apparatuses.

When the polymerization reactor is in the state of being emplaced, the stirrer shaft of the stirrer placed in the reaction tank may be arranged in an approximately vertical direction (that is, the direction that can be deemed to be parallel to the gravity direction in the technical field of the present invention), or the stirrer shaft of the stirrer placed in the reaction tank may be arranged in an approximately horizontal direction (that is, the direction that can be deemed to be perpendicular to the gravity direction in the technical field of the present invention).

In the present invention, the polymerization reactor in which the stirrer shaft of the stirrer is arranged in the approximately vertical direction when the polymerization reactor is in the state of being emplaced, is referred to as a “vertically arranged reactor” or as a “vertical reactor”. Also in the present invention, the polymerization reactor in which the stirrer shaft of the stirrer is arranged in the approximately horizontal direction when the polymerization reactor is in the state of being emplaced, is referred to as a “horizontally arranged reactor” or as a “horizontal reactor”.

When the polymerization reactor is the horizontally arranged reactor, generally, a catalyst feed port is disposed at the gravity directional upper part of one end side of the reaction tank; one or more starting material feed ports are disposed between one end side and the other end side of the reaction tank; and a draw port for drawing a reaction product is disposed at the gravity directional lower part of the other end side of the reaction tank. In the case of carrying out continuous polymerization, the position of the end portion where the catalyst feed port of the reaction tank is disposed, is the upstream side of the material flowing direction, and the position of the end portion where the reaction product draw port of the reaction tank is disposed, is the downstream side of the material flowing direction.

The stirrer shaft of the stirrer is axis-rotatably born by the bearing disposed at one or more positions including one end side of the stirrer shaft. Also, a drive system such as a motor is connected to the stirrer shaft. By rotating the stirring blades of the stirrer in the reaction tank, homogeneous polymerization can be efficiently carried out, while stirring the starting materials and the reaction product.

The shape of the stirring blades is not particularly limited. For example, it may be a vane shape, a screw shape or the like. There is no particular limitation on other properties of the stirring blades, such as the size (length, width, thickness), the position on the stirrer shaft, the azimuth angle in a rotation direction of the stirrer shaft, and the inclination angle with respect to the rotational direction, and they may be appropriately determined considering the stirring force, the force for carrying the materials in the flow direction, or the like.

The bearing used in the present invention is not particularly limited, as long as it is a type using a lubricant. It may be a sliding bearing, or it may be a rolling bearing selected from the group consisting of a radial ball bearing, a radial roller bearing, a thrust ball bearing, a thrust roller bearing and the like.

In the polymerization reactor of the present invention, as a lubricant, a fluorine-based oil is used in a gap between the surface of the stirrer shaft of the stirrer and the opposite inner surface of the bearing.

In the present invention, the fluorine-based oil is a substance such that a part or all of hydrogen atoms in an organic compound having a carbon-hydrogen bond are substituted with fluorine. The substance may further contain other atoms, for example, halogen such as chlorine and bromine, phosphorus, sulfur, oxygen and nitrogen, and so on.

The fluorine-based oil used in the present invention is free of a thickener. Meanwhile, the grease that has been used in the bearing of the stirrer shaft of conventional polymerization reactors, is a semi-solid lubricant prepared by adding a thickener to a base oil, and it is distinguishable from the fluorine-based oil used in the present invention. In the present invention, “free of a thickener” means that the thickener is approximately 1 wt. % or less of the whole oil amount, and it is preferably 0 wt. %.

The fluorine-based oil used in the present invention preferably has at least one of the following two properties.

### (1) Kinematic Viscosity

The kinematic viscosity of the fluorine-based oil at 40° C. is preferably from 20 mm²/s to 1000 mm²/s, and more preferably from 50 mm²/s to 700 mm²/s.

### (2) Viscosity Index

The viscosity index of the fluorine-based oil is preferably from 60 to 200, and more preferably from 100 to 200. The viscosity index is calculated from a kinematic viscosity at 40° C. and a kinematic viscosity at 100° C., according to JIS K2283.

As the fluorine-based oil, examples include, but are not limited to, a fluorine atom-containing compound such as perfluoropolyether, chlorotrifluoroethylene low polymer and polytetrafluoroethylene. They may be used alone or in combination of two or more. Among them, perfluoropolyether is preferably used. The number average molecular weight of perfluoropolyether is preferably from 1000 to 15000, and more preferably from 5000 to 12000.

The fluorine-based oil has high visibility of contaminants. Accordingly, when foreign substances such as iron powder are present in the oil, they can be easily observed by eye, and the observation results can be used for maintenance and management of the reactor. For example, by monitoring the concentration of the iron powder in the oil, signs of deterioration of the bearing part can be detected early, and by replacing or repairing consumed small components only, it is possible to avoid large-scale damage to the stirrer or the bearing, and heavy damage such as a shutdown of the entire polymerization plant.

Perfluoropolyether is available as a commercial product. For example, BARRIERTA J400 as product name, (general name: perfluoropolyether, number average molecular weight: 7500, manufactured by: NOK Kluber Co., Ltd.), BARRIERTA J400V as product name (general name: perfluoropolyether, number average molecular weight: 7500, manufactured by: NOK Kluber Co., Ltd.) or the like can be used.

The fluorine-based oil used in the present invention has high lubricity and appropriate flowability; moreover, it has long-term stability such as high heat resistance and high chemical resistance. Accordingly, by applying the fluorine-based oil to a frictional interface between the stirrer shaft of the stirrer and the bearing thereof, excellent lubricity is imparted to the frictional interface therebetween; stable lubrication performance is kept for a long period of time; and the stirrer is prevented from damage induced by long-term continuous operation. Therefore, according to the present invention, smooth and stable stirring performance and high stirrer durability can be achieved.

When the used lubricant is a commonly used lubricant, it is presumed that since the raw material monomer used in the present invention is dissolved into the lubricant to reduce the viscosity of the lubricant, the stirring performance of the stirrer deteriorates due to the raw material monomer.

When the fluorine-based oil is used as the lubricant, it is presumed that since the raw material monomer has low solubility into the fluorine-based oil and a reduction in the viscosity of the fluorine-based oil due to the dissolution of the raw material monomer is less likely to occur, the stirring performance of the stirrer or the function of the bearing does not deteriorate.

Especially, even when the polymerization reactor of the present invention is used for a long period of time in the process of polymerization of olefin-based monomers such as propylene and ethylene, smooth and stable stirring performance and high stirrer durability can be achieved. Accordingly, the polymerization reactor of the present invention can be suitably used in homopolymerization or copolymerization of the olefin-based monomer, especially in propylene homopolymerization or copolymerization.

The present invention is applicable to any of the following polymerization processes: the slurry polymerization method, the bulk polymerization method and the vapor phase polymerization method. As a typical example, the case of applying the present invention to the vapor phase polymerization method will be described below.

The vapor phase polymerization method is a polymerization reaction in which a phase for carrying out the polymerization is substantially a gas phase. In the present invention, the vapor phase polymerization method does not mean the complete absence of liquid in the phase for carrying out the polymerization. The phase for carrying out the polymerization may be substantially a gas phase, and liquid may be present without deviating from the gist of the present invention. As the liquid that may be used in a small amount in the vapor phase polymerization method, examples include, but are not limited to, a liquefied monomer for heat removal, and inert hydrocarbon such as hexane.

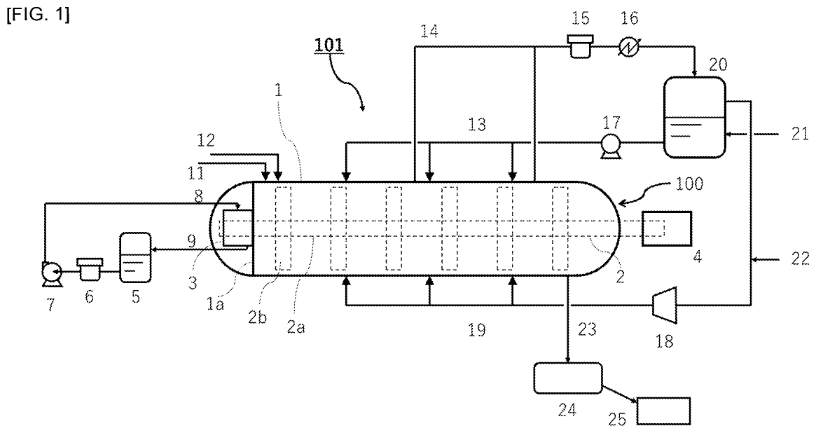

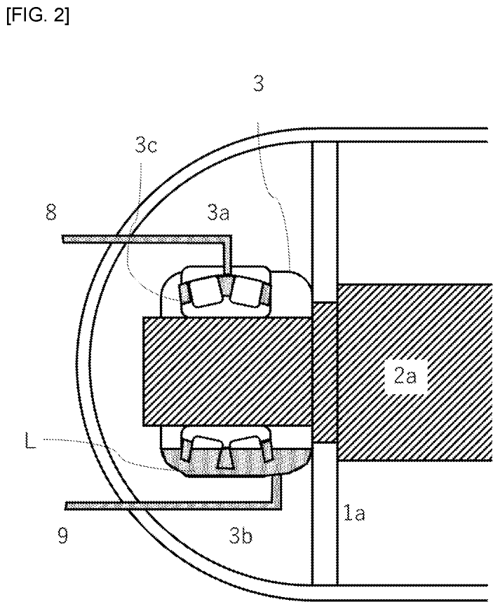

FIG. 1 is a diagram showing an exemplary structure of a polymerization reaction system (polymerization system 101) which includes a horizontal polymerization reactor (reactor 100) for carrying out continuous polymerization in the vapor phase polymerization method. The reactor 100 shown in FIG. 1 is illustrated as a schematic sectional diagram. FIG. 2 is a schematic enlarged diagram showing a part of one end of a stirrer shaft in the reactor 100, the end being born by a bearing.

In FIG. 1, the reaction tank 1 is a hollow container in a wholly elongated shape, which is composed of a cylindrical trunk portion and semispherical tank-end portions connected to both ends of the trunk portion. The reaction tank 1 is horizontally arranged when the reactor 100 is in the state of being emplaced.

The polymerization reaction is carried out in the internal space of the reaction tank 1. In the case of the reactor 100, a partition wall 1a is the upstream end of reaction and the reactor has a reaction space enclosed by the inner surface of the trunk portion of the reaction tank, the inner surface of the upstream partition wall, and the inner surface of the downstream tank-end portion.

A stirrer 2 is placed in the internal space of the reaction tank 1, the stirrer comprising at least a stirrer shaft 2a and stirring blades 2b fixed on the stirrer shaft, and the stirrer shaft 2a of the stirrer is arranged to coincide with the longitudinal-direction central axis of the reaction tank. In the internal space at one end side of the reaction tank 1, a bearing 3 is disposed between the semispherical tank-end portion and the partition wall 1a. In addition, as a drive system for axially rotating the stirrer shaft, a motor 4 is disposed outside of the other end side of the reaction tank 1. One end of the stirrer shaft 2a penetrates the partition wall 1a and is inserted into the bearing 3, thereby being axis-rotatably born. The other end of the stirrer shaft 2a penetrates the outer wall of the reaction tank 1 and is connected to the motor 4.

As shown in FIG. 2, the bearing 3 is placed in the inside of the reaction tank 1, and it includes an inner supply channel 3a, which is a channel for supplying the fluorine-based oil as the lubricant to the gap between the inner surface of the bearing and the surface of the stirrer shaft, and an inner discharge channel 3b, which is a channel for discharging the fluorine-based oil from the gap. A lubricant reservoir 5 is connected to the inlet of the inner supply channel 3a by a lubricant supply pipeline 8 including a filter 6 and a pump 7. The inner discharge channel 3b is connected to a lubricant discharge pipeline 9. The inner supply channel 3a and the lubricant supply pipeline 8 are connected so as to penetrate the outer wall of the reaction tank 1. Similarly, the inner discharge channel 3b and the lubricant discharge pipeline 9 are connected so as to penetrate the outer wall of the reaction tank 1.

By the driving force of the pump 7, the fluorine-based oil is supplied from the lubricant reservoir 5 through the lubricant supply pipeline 8 to the inner supply channel 3a of the bearing 3 and then to the gap (a lubricated surface) 3c between the inner surface of the bearing and the surface of the stirrer shaft, thereby exerting lubrication action. The supplied fluorine-based oil L is discharged through the inner discharge channel 3b and the lubricant discharge pipeline 9.

The desired polymer can be synthesized by vapor phase polymerization that is carried out by supplying starting materials such as a catalyst and a raw material monomer to the reaction tank 1, while rotating the stirrer 2 of the above-described reactor 100.

A method for producing an olefin-based polymer by vapor phase polymerization with the polymerization system 101 including the reactor 100, will be described below.

In the polymerization system 101, the polymerization generates polymerization heat, and the removal of polymerization heat is carried out by use of the vaporization heat (evaporation latent heat) of liquefied propylene. Accordingly, the polymerization system 101 includes a recycle device for drawing propylene-containing gas from the reaction tank, liquefying at least a part of the gas by cooling, and then supplying at least a part of the liquefied component to the reaction tank.

In the polymerization system 101, catalyst component feed ports 11 and 12 are disposed at the gravity directional upper part of the reaction tank 1 and in the vicinity of the upstream end portion of reaction. In addition, raw material monomer feed ports connected to a raw material monomer feed pipeline 13 are disposed at more downstream side than the catalyst component feed ports 11 and 12. The catalyst, a cocatalyst and so on are introduced from the catalyst component feed ports 11 and 12 to the reaction tank 1; meanwhile, liquefied propylene, which is a raw material, is introduced from the raw material monomer feed ports to the reaction tank 1, thereby initiating the polymerization. The catalyst component feed ports 11 and 12 can be disposed at any positions, insofar as deviation from the gist of the present invention is not derived. As needed, only one catalyst component feed port can be disposed.

The catalyst is not particularly limited, as long as it is a catalyst that can be used for polymerization of olefin-based monomers. For example, a Ziegler catalyst or a metallocene catalyst can be used. Other components constituting the polymerization catalyst, such as an organoaluminum compound, may be supplied as the components in the catalyst, after they are brought into contact with a Ziegler-based solid catalyst component or a metallocene complex, or they may be supplied separately from these components. The catalyst is in a powder form and may be supplied as it is to the reaction tank, or the catalyst may be supplied after it is diluted with an inert solvent such as liquid saturated hydrocarbon and mineral oil.

The polymerization heat generated during the polymerization is removed by the vaporization heat of the raw material liquefied propylene supplied from the raw material monomer feed pipeline 13 disposed at the gravity directional upper part of the reaction tank 1. Unreacted propylene gas is discharged to the outside of the reaction system from an unreacted gas draw pipeline 14 disposed at the gravity directional upper part of the reaction tank 1; the discharged unreacted propylene gas passes through a bag filter 15; a part of the gas is condensed in a condenser 16; and the condensed gas is separated into a liquid phase and a vapor phase in a gas-liquid separation tank 20. For the removal of the polymerization heat, the liquid phase part is re-introduced into the raw material monomer feed pipeline 13 by the driving force of a pump 17. The vapor phase part is mixed with hydrogen and so on for molecular weight control, and the mixture is re-supplied by the driving force of a compressor 18 through a raw material monomer gas supply pipeline 19 disposed at the gravity directional lower part of the reaction tank 1. Polymer particles, which are a reaction product, are transferred from the upstream part to the downstream part in the reaction tank, while they are mixed by stirring; they are discharged from a polymer draw pipeline 23 to the outside of the reaction system; the discharged polymer particles are separated by a gas recovery device 24; and then the separated polymer particles are recovered into a powder recovery device 25.

Raw material propylene is supplied to the gas-liquid separation tank 20 by a raw material propylene supply pipeline 21. When other materials (such as a comonomer and hydrogen) are gaseous materials, they are supplied into the reaction system by a raw material gas supply pipeline 22. When they are liquid materials, they are supplied into the reaction system by the raw material propylene supply pipeline 21.

In the case of producing the olefin-based polymer by the vapor phase polymerization method using the polymerization reactor of the present invention, there is no particular limitation on the raw material monomer and the comonomer which is used as needed. They can be appropriately selected from olefin monomers.

As the raw material monomer (the main monomer), an α-olefin monomer containing 5 carbon atoms or less is preferably used, and propylene is particularly preferred.

As the comonomer, an α-olefin monomer different from the raw material monomer is preferably used, which is selected from α-olefin monomers containing 2 or more and 20 or less carbon atoms, such as ethylene, 1-butene, 3-methyl-1-butene, 4-methyl-1-pentene, 3-methyl-1-pentene, 4-methyl-1-hexene, 4,4-dimethyl-1-hexene, 1-nonene, 1-octene, 1-heptene, 1-hexene, 1-decene, 1-undecene and 1-dodecene.

The raw material monomer and comonomers introduced into the reaction tank 1 are brought into contact with the catalyst in the gas phase state, while they are polymerized and stirred with the reaction product by the stirrer to synthesize the olefin-based polymer. In the polymerization reaction of the raw material monomer and the comonomers, hydrogen serves as a molecular weight regulator.

The polymerization conditions of the vapor phase polymerization method, such as temperature and pressure, are not particularly limited, and they can be optionally determined according to the raw material monomer. When the raw material monomer is propylene, the reaction temperature, the polymerization pressure and the residence time in the reaction tank are as follows.

As for the reaction temperature, the lower limit is preferably 0° C. or more, more preferably 30° C. or more, and particularly preferably 40° C. or more; moreover, the upper limit is preferably 100° C. or less, more preferably 90° C. or less, and particularly preferably 80° C. or less.

As for the polymerization pressure, the lower limit is equal to or more than the atmospheric pressure, and it is preferably 600 kPaG or more, more preferably 1000 kPaG or more, and particularly preferably 1600 kPaG or more; moreover, the upper limit is preferably 4200 kPaG or less, more preferably 3500 kPaG or less, and particularly preferably 3000 kPaG or less.

The residence time in the reaction tank is optionally adjusted according to the structure of the reactor or product index. In general, the residence time is set in a range of from 30 minutes to 10 hours.

The stirring speed of the stirrer is optionally adjusted according to the structure of the reactor or product index. In general, the stirring speed is set as a rotational frequency in a range of from of 10 min⁻¹ to 50 min⁻¹.

### EXAMPLES

Hereinafter, the present disclosure will be described in more detail, with reference to examples. However, the present invention is not limited to these examples.

In the following examples, long-term propylene polymerization was continuously carried out by use of a propylene polymerization apparatus including a stirrer provided with a stirrer shaft. In the process of long-term use of the propylene polymerization apparatus, the lubricant of a bearing, which was disposed inside the propylene polymerization apparatus for bearing the stirrer shaft, was changed to observe the time degradation of the bearing and the stirrer shaft.

### 1. First-Stage Test (Comparative Example 1)

Long-term continuous polymerization was carried out in the following polymerization conditions, by use of the propylene polymerization apparatus of the following structure.

### (1) Structure of the Propylene Polymerization Apparatus Used in the First-Stage Test

A horizontal vapor phase polymerization reactor was used, wherein the reactor includes a straight trunk portion with a length of 9.6 m, a diameter of 1.8 m and a volume of about 25 m³, and a stirrer shaft with a diameter of 0.6 m and being provided with paddle-type stirring blades. The rotational frequency of the stirrer shaft was 18 min⁻¹.

### (2) Lubricant Used for the Bearing

Lubricant: NEVASOL 2 (grease) as product name (manufactured by Mitsui Oil Co., Ltd.)
Kinematic viscosity (40° C.) of a base oil: 260 mm²/s
Oil film parameter: 0.7
Lubrication coefficient: 0.1

### (3) Polymerization Conditions

Polymerization temperature: 65° C. to 70° C.
Polymerization pressure: 2.4 MPaG
Propylene homo vapor phase polymerization and propylene-ethylene random vapor phase polymerization

### (4) Accumulated Operation Time

Accumulated operation time: About 30000 hours

### (5) Test Results

The bearing part was seriously damaged when an accumulated operation time of about 30000 hours passed. Accordingly, the polymerization was halted.

### 2. Second-Stage Test (Comparative Example 2)

The propylene polymerization apparatus used in the first-stage test was repaired and continuously used; the lubricant was changed to a different grease; and long-term continuous polymerization was carried out in the following polymerization conditions.

### (1) Structure of the Propylene Polymerization Apparatus Used in the Second-Stage Test

The structure of the apparatus was the same as the structure of that used in the first-stage test.

### (2) Lubricant Used for the Bearing

Lubricant: The lubricant was changed from NEVASOL 2 (grease) to NIGLUBE RM (grease) as product name (manufactured by Nippon Grease Co., Ltd.) Compared to NEVASOL 2 (grease) used in the first-stage test, NIGLUBE RM (grease) had a large kinematic viscosity of a base oil, small propylene solubility, a large oil film parameter and a large lubrication coefficient. Accordingly, NIGLUBE RM was expected to keep better lubrication performance than the first-stage test for a long period of time.
Kinematic viscosity (40° C.) of a base oil: 580 mm²/s
Propylene solubility: Smaller propylene solubility than NEVASOL 2 (grease)
Oil film parameter: 1.5
Lubrication coefficient: 1 or more

### (3) Polymerization Conditions

The polymerization conditions of the second-stage test were the same as those of the first-stage test.

### (4) Accumulated Operation Time

Accumulated operation time: About 15000 hours

### (5) Test Results

The bearing part was seriously damaged at the end of the operation time.

The life of the bearing part could not be extended.

### 3. Third-Stage Test (Example 1)

The propylene polymerization apparatus used in the second-stage test was repaired and continuously used; the lubricant was changed to fluorine-based oil; and long-term continuous polymerization was carried out in the following polymerization conditions.

### (1) Structure of the Propylene Polymerization Apparatus Used in the Third-Stage Test

The structure of the apparatus was the same as the structure of that used in the second-stage test.

### (2) Lubricant Used for the Bearing

Lubricant: BARRIERTA J400 as product name (fluorine-based oil (perfluoropolyether), manufactured by NOK Kluber Co., Ltd.) was used.
Kinematic viscosity (40° C.): 390 mm²/s
Viscosity index: 140

### (3) Polymerization Conditions

The polymerization conditions of the third-stage test were the same as those of the first-stage test.

### (4) Operation Period and Accumulated Operation Time

Accumulated operation time: About 50000 hours

### (5) Test Results

The bearing part was not damaged when the operation period passed, and the operation continued.

### [Table 1]

| | | | |
|---|---|---|---|
| Lubricant | NEVASOL 2 | NIGLUBE RM | BARRIERTA J400 |
| | (Grease) | (Grease) | (Fluorine-based oil) |
| Accumulated | 30000 | 15000 | 50000 |
| operation | | | |
| time (hours) | | | |
| Results | The bearing | The bearing | In operation |
| | was seriously | was seriously | |
| | damaged. | damaged. | |

### Considerations of the Examples

In the case of using the greases as the lubricant of the bearing, the bearing was seriously damaged in about 2 to 4 years of operation of the propylene polymerization apparatus.

Even after changing the grease type, the effect of extending the life of the bearing of the propylene polymerization apparatus, was not seen.

By using the fluorine-based oil as the lubricant of the bearing, the effect of extending the life of the bearing of the propylene polymerization apparatus, which enabled continuous operation for about 6 or more years, was seen.

### REFERENCE SYMBOLS LIST

100. Reactor
101. Polymerization system
1. Reaction tank
1a. Partition wall
2. Stirrer
2a. Stirrer shaft
2b. Stirring blade
3. Bearing
3a. Inner supply channel
3b. Inner discharge channel
3c. Lubricated surface
4. Motor
5. Lubricant reservoir
6. Filter
7. Pump
8. Lubricant supply pipeline
9. Lubricant discharge pipeline
11, 12. Catalyst component feed pipeline
13. Raw material monomer feed pipeline
14. Unreacted gas draw pipeline
15. Bag filter
16. Condenser
17. Pump
18. Compressor
19. Raw material monomer gas supply pipeline
20. Gas-liquid separation tank
21. Raw material propylene supply pipeline
22. Raw material gas supply pipeline (comonomer, hydrogen, etc.)
23. Polymer draw pipeline
24. Gas recovery device
25. Powder recovery device
L. Lubricant (Fluorine-based oil)

1. A polymerization reactor comprising:
a reaction tank,
a stirrer which is disposed inside the reaction tank and which has a stirrer shaft and stirring blades fixed on the stirrer shaft, and
a bearing which is at least disposed at a side where one end of the stirrer shaft is present and which bears an end portion of the stirrer shaft,
wherein, as a lubricant, a fluorine-based oil is used in a gap between the stirrer shaft and the bearing.

2. The polymerization reactor according to claim 1, wherein the fluorine-based oil is perfluoropolyether.

3. The polymerization reactor according to claim 1 or 2, wherein the reactor is a horizontally arranged reactor in which the stirrer shaft of the stirrer disposed inside the reaction tank is arranged in an approximately horizontal direction.

4. The polymerization reactor according to any one of claims 1 to 3, wherein the reactor is used for olefin polymerization.

5. The polymerization reactor according to claim 4, wherein the olefin polymerization is propylene polymerization.

6. A method for producing a propylene-based polymer, wherein the polymerization reactor defined by any one of claims 1 to 5 is used.
